(19) United States
(12) Patent Application Publication
(10) Pub. No.: US 2021/0370157 A1
(43) Pub. Date: Dec. 2, 2021

(54) DEVICE FOR DRIVING A PAIR OF SKIS OR A SURFBOARD

(71) Applicant: Arnaud BALLU, BIVIERS (FR)

(72) Inventor: Arnaud BALLU, BIVIERS (FR)

(21) Appl. No.: 16/979,814

(22) PCT Filed: Mar. 9, 2019
(86) PCT No.: PCT/EP2019/055936

§ 371 Date: Sep. 10, 2020

(30) Foreign Application Priority Data
Mar. 11, 2018 (FR) 18/70265

(51) Int. Cl. A63C 5/06; A63C 5/03

(52) U.S. Cl. CPC A63C 5/06; B62B 13/046; A63C 5/033

(57) ABSTRACT

A device allowing the control of a pair of skis or a surfboard, in particular for snow, by the combined simple rotation and simple tilting of a single drive member such as a handlebar, simultaneously by lateral inclination and by longitudinal warping. It therefore combines the necessary mechanical functionalities of a pair of conventional fasteners with the ease of use of a bicycle and does not require skis or specific surfboard. It allows you to move freely over the snow by driving with both feet which are retained but not locked, or to use one foot to push on the flat and stabilize. The lever arm offered by the drive body is much greater than that of a pair of conventional fasteners, greatly improving the ease of use and the maximum capabilities of the machine. Finally, it instantly folds back for easy handling and storage.

### CROSS REFERENCE TO RELATED APPLICATIONS

This application is a National Stage of PCT Application No. PCT/EP2019/055936 filed on Mar. 9, 2019, which claims priority to French Patent Application No. 18/70265 filed on Mar. 11, 2018, the contents each of which are incorporated herein by reference thereto.

### FIELD

The present application concerns a device for driving a pair of skis or a surfboard, in particular for snow.

### STATE OF THE ART

It is well known to achieve multiple forms of controlling of the user on skis or a snowboard without necessarily having the feet locked on the support.

A known device consists in using the principle of the bicycle by fastening a first surfboard which is rigid and of substantially reduced dimensions to the fixed rear portion of a frame equipped, in its front portion, with a steering column surmounted by a handlebar. The lower end of this steering member is equipped with a second board, generally of smaller dimensions than that fastened on the rear. It is known that this equipment does not really reproduce the dynamic behavior of a bicycle or that of a snowboard and its bulk constitutes a major drawback. In addition, it does not reproduce the twist conventionally imposed on a surfboard or a ski.

### OBJECT OF THE INVENTION

The object of the present invention consists in providing a device for controlling a pair of skis or a surfboard, in particular for snow, by the combined simple rotation and simple tilting of a single drive member such as a handlebar, simultaneously by lateral inclination and by longitudinal warping. It therefore combines the necessary mechanical functionalities of a pair of conventional fasteners with the ease of use of a bicycle and does not require specific surfboard or pair of skis. It allows you to move freely over the snow by driving with both feet which are retained but not locked, or to use one foot to push on the flat and stabilize. Finally, it instantly folds back for easy handling and storage.

This device is indistinctly fastened, by means of conventional screws or inserts and via at least one fastening base, on a large number of gliding supports used to be displaced on different terrains, among others on the snow. The device is described below for a pair of ski or a snowboard, without limitation.

This device for controlling a pair of skis or a surfboard, in particular for snow, comprises a first zone z for fastening the feet, located substantially on a first half of the board/pair of skis, preferably located mostly in the second fifth of the board/pair of skis, and composed in particular of screw inserts or integrated supports capable of receiving screws, disposed on either side of an axis A longitudinally passing through the board/pair of skis in the center of gravity thereof; the perpendicular of the board/pair of skis with the axis A at the zone z forming a first plane P; a second zone for fastening the feet z′ identical to the first zone, located substantially on the second half of the board/pair of skis, preferably located mostly in the fourth fifth of the board, the perpendicular of the board/pair of skis with the axis A at the zone z′ forming a second plane P′.

This device for driving is characterized in that it includes:
a first connecting element, of adapted shape and length, secured to the board/pair of skis by a first end and a first base at the zone z and constrained at least parallel to the plane P in a point o′ of the second end thereof;
a second connecting element, of adapted shape and length, secured to the board/pair of skis by a first end and a second base at the zone z′ and constrained at least parallel to the plane P′ in a point o of the second end thereof;
a third warping element, of adapted shape and length, secured to the first connecting element at least at the point o′, of the second connecting element at least at the point o, and maintaining a fixed and predetermined distance between the points o′ and o;

The free mobilization of the warping element imposing an offset of the point o relative to the plane P and of the point o′ relative to the plane P′.

The document FR 2 732 609 describes a snowboard controlled by at least one handle and the document US 2006/197294 describes a device for controlling a foldable ski vehicle operating by gravity.

### BRIEF DESCRIPTION OF THE DRAWINGS

The invention will be better understood with reference to the figures:

FIG. 1A represents a general perspective view of a pair of skis equipped with an embodiment of the device according to the invention, at rest, and showing different elements, axes and planes describing the invention and its kinematics.

FIG. 1B represents a general perspective view of a surfboard equipped with an embodiment of the device according to the invention, at rest, and showing different elements, axes and planes describing the invention and its kinematics.

FIG. 2A represents a perspective view of a pair of skis and the bases thereof according to the invention.

FIG. 2B represents a perspective view of a surfboard and the bases thereof according to the invention.

FIG. 3 represents a detailed perspective view of an embodiment of a connecting element.

FIG. 4 represents a detailed perspective view of an embodiment of another connecting element.

FIG. 5 represents a general profile view of an embodiment of a warping system and geometric elements governing the kinematics of the invention.

FIG. 6 represents a detailed perspective view of an embodiment of a removable connector.

FIGS. 7A and 7B each represent a perspective view of the principle according to the invention and in two different positions.

FIGS. 8A and 8B represent respectively a perspective view and a front view of a surfboard equipped with the device according to the invention, and whose drive member is mobilized in a counterclockwise direction, generating a warping angle h according to the plans P and P′.

FIGS. 9A and 9B respectively represent a perspective view and a front view of a surfboard equipped with the device according to the invention, and whose drive member is mobilized in a clockwise direction, generating a warping angle h′ according to the plans P and P′.

FIG. 10 represents a perspective view of a surfboard equipped with the device according to the invention, in the folded position.

FIG. 11 represents a perspective view of a variant of the device according to the invention.

### DESCRIPTION OF A PREFERRED EMBODIMENT OF THE INVENTION

Unless otherwise specified, the terms “about” and “substantially” mean within 10%, preferably within 5%.

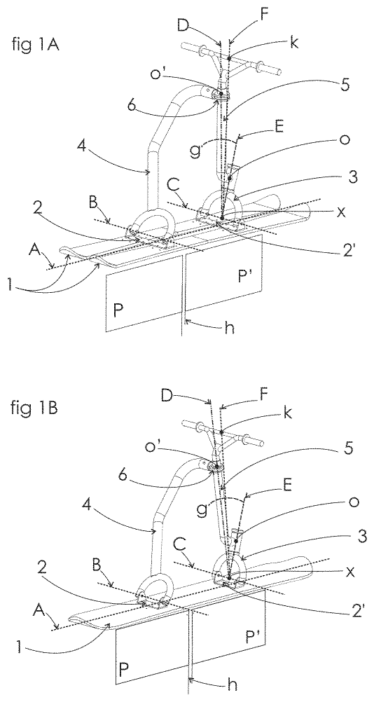

With reference to the figures, a gliding support 1 such as a pair of skis (FIG. 1A) or a surfboard (FIG. 1B) of the same type as those usually found in commerce is equipped with a preferred embodiment of the device according to the invention.

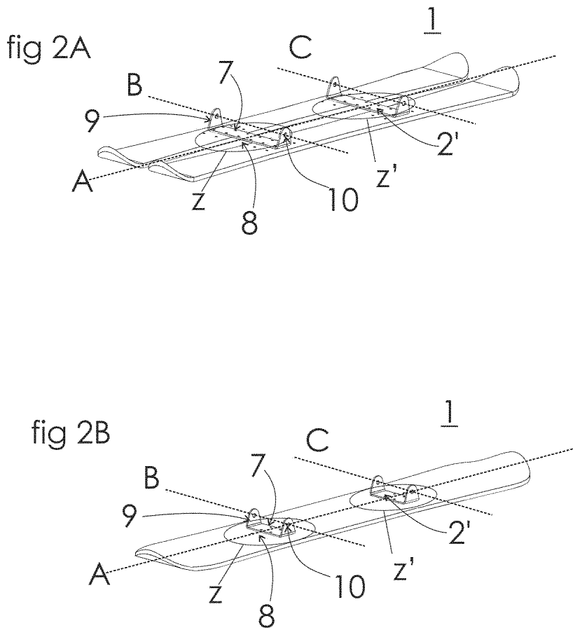

The device according to the invention includes two zones for fastening the feet z and z′, represented in FIG. 2, each located substantially on an opposite half of the board or of a ski. These fastening zones are equipped with embedded metal inserts allowing fasteners to be secured thereto by means of screws. These groups of inserts are generally more numerous than the number that can be used by the conventional fasteners in order to have a longitudinal adjustment range. Another known method is to integrate reinforcements integrated into the skis allowing appropriate screws to be directly fastened thereto. Another known means is to use rails on the gliding support allowing sliding the base(s) in order to precisely adjust the location of the latter on said support.

A first base 2 is conventionally disposed on the first zone z by means of fastening holes 7 and screws (not represented) and collaborating if necessary with inserts 8. An axis A longitudinally crosses the board or the pair of skis 1 in its middle. The base 2 is therefore disposed on either side of the longitudinal axis A and has on each side two axis lugs 9 each equipped with an axis hole 10, these two holes 10 being coaxial along a transverse axis B. The base 2 is dimensioned and made of a resistant material such as metal or composite fibers allowing withstanding the stresses to which it is subjected while keeping low weight and bulk. The width thereof on the board or the pair of skis 1 allows, among others, to easily engage the foot therein. A base is preferably equipped with anti-slip means on the upper portion thereof in order to obtain a better hold of the foot while leaving it relatively free of its accurate engagement and positioning.

A second base 2′ identical to the first base 2 is disposed in the same manner at the second zone z′ of the board or the pair of skis 1 and defines, in the same manner, an axis C which is transverse and parallel to the axis B. The base 2′ is therefore disposed on either side of the longitudinal axis A and has on each side two axis lugs 9′ equipped with an axis hole 10′, these two holes 10′ being co-axial along the transverse axis C. According to a variant, the bases 2 and 2′ are not identical.

In the preferred embodiment according to the invention where the device is used to drive a pair of skis, the bases 2 and 2′ secure, by means of screws not represented, the two skis to each other, imposing on them a predetermined spacing and alignment. Thus each of the skis will be subject distinctly to the stresses imposed by the irregularities of the terrain, but the device according to the invention will mobilize them indistinctly as an integral assembly, in particular for the longitudinal torsional stresses. By this arrangement, the constituted pair of skis is similar to a surfboard cut in the length thereof along the longitudinal axis A.

A user can place a first foot on the first zone z and a second foot on the second zone z′, i.e. preferably one foot on a first half of the board or of the pair of skis and another on the second half of said gliding support. Therefore and even more preferably, by dividing the board or the pair of skis along the length into five successive portions of the same length, the majority of the bearing surface of the first foot on the board or the pair of skis 1 is located in the second portion of the board or the pair of skis and the majority of the bearing surface of the first foot on the board or the pair of skis 1 is located in the fourth portion.

A plane P is defined (as represented in FIG. 1) perpendicular to the board or the pair of skis 1 and to the axis B at the zone z. A second plane P′ is also defined perpendicular to the upper face of the board or the pair of skis 1 and to the axis C at the zone z′. The angle between the planes P and P′ is called h. When the board or the pair of skis 1 is at rest, the planes P and P′ are parallel and the warping angle h therebetween is therefore zero.

A first connecting element 4, represented alone in FIG. 4, is pivotally connected to the base 2 at the level of the zone z by a first low end 15, in particular thanks to removable axes 11 such as screws or pins, and disposed coaxially with the axis B. The end 15 can form a housing allowing the rear foot of a user to be engaged therein in an inverted «U»-shape. The width of the end 15 is dimensioned so as to withstand lever stresses exerted on either side of the longitudinal axis A on the connecting element 4. The second upper end 17 of the connecting element 4 is in particular tubular and hollow in shape, forming a cylindrical housing 18, and equipped with a radial axis hole 19 collaborating with a removable axis such as a pin 20. The main body 16 of the connecting element 4 of predetermined shape and length, firmly connects the two ends 15 and 17 to each other. The shape thereof is asymmetric according to the preferred embodiment and the plane P, in order to allow bypassing the legs, or even the pelvis, of a user standing normally straight on the board or pair of skis 1. In addition, in the case of pronounced bending of the legs, in particular during a jump landing, it is important to avoid any contact with the structure of the machine. The connecting element 4 is therefore not rectilinear in the preferred embodiment. According to one embodiment, considering a reference plane containing the axis A and the point o′, more than 75% by volume of the connecting element 4 is located on one side of the reference plane. This arrangement is easily reversible by means of the removable axes 11, such that the user can choose on which side to put the connecting element 4. Thus the body 16 of the connecting element 4 is positioned on either side of the legs of the user. In general, the elements for fastening the connecting element 4 to the board or the pair of skis 1 are adapted to allow mounting the connecting element 4 oriented on one side of the reference plane or on the other side of the reference plane.

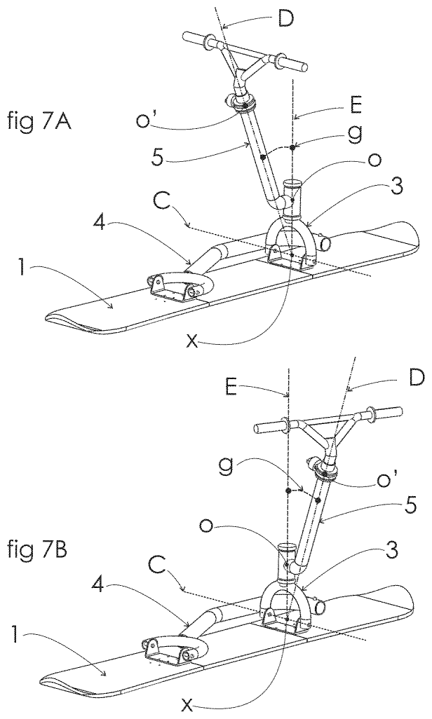

This connecting element 4 can pivot freely (as for example represented in FIG. 7A) about the axis B when it is not constrained by other elements. It always remains constrained parallel to the plane P. The distance which can separate the end 17 from the plane P is predetermined and constant. The overall dimensioning as well as the construction materials of the connecting element 4 are likely to maintain this predetermined distance and to best resist any lateral bending stress. It is in particular made of aluminum profile or of composite fibers to combine strength and lightness. The width of the end 15 is dimensioned so as to withstand the lever stresses exerted on either side of the longitudinal axis A on the connecting element 4.

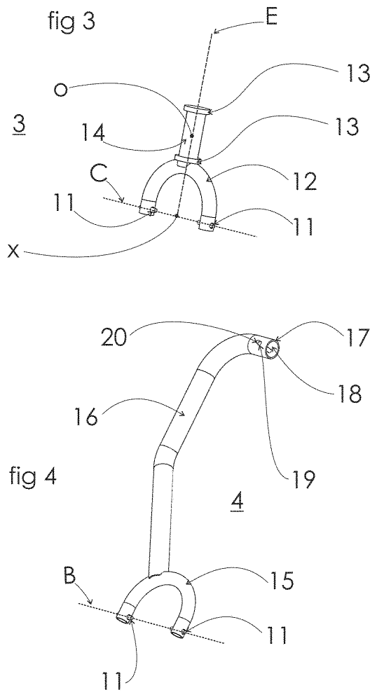

A second connecting element 3, represented alone in FIG. 3, is pivotally connected, by means of removable axes 11 such as screws or pins disposed coaxially along the axis C, to the base 2′ at the zone z′, by a first lower end 12, forming in particular a housing allowing engaging the other foot of the user therein. A second upper cylindrical end constitutes a male shaft 14, and acts as an axis of rotation along a warping axis E. This shaft 14 is equipped on either side with two retaining rings 13. These rings are fastened by appropriate means which are not represented. The connecting element 3 can pivot about the axis C when it is not constrained by other elements (as for example represented in FIG. 7A). It always remains constrained parallel to the plane P′. The center of gravity of the shaft 14 is materialized in a point o. Thus the distance which can separate the point o from the plane P′, zero according to this embodiment, however remains predetermined and constant. The warping axis E is coaxial with the shaft 14 and parallel to the plane P′. A point x represents the meeting point between the axis C and the axis E. The overall dimensioning as well as the construction materials of the connecting element 3 are likely to keep this predetermined distance and to best withstand any lateral bending stress. The connecting element 3 is constrained parallel to the plane P′. It is in particular made of aluminum profile or composite materials to combine strength and lightness. The width of the end 12 is dimensioned so as to withstand lever stresses exerted on either side of the longitudinal axis A on the connecting element 3.

According to a variant not represented, the respective lower portions 15 and 12 of the connecting elements 4 and 3 are in particular in the shape of a left or right «L», or even an inverted «T» shape, these shapes then replacing the shape described inverted «U»-shape according to the preferred embodiment.

A warping element 5, described in relation to FIGS. 1, 5 and 7, has a low female end 21 of hollow cylindrical shape and acting as a bore. The center of gravity of the end 21 is located on the point o. It is recalled that the warping axis E passes through the point o. It crosses the axis C in a point x. This axis E is coaxial with the cylindrical shape of the end 21 which judiciously collaborates in diameter and in length with the male shaft 14 of the connecting element 3. The end 21 is held captive without excessive clearance between the two rings. 13 of the connecting element 3. Antifriction bearings, not represented, may be disposed between the end 21 and the shaft 14.

The ends 21 and 14 collaborate coaxially with each other over a sufficient length to prevent any freedom other than the rotation between the connecting element 3 and the warping element 5 and withstand the axial dissociation stresses. This length is ideally comprised between 20 mm and 200 mm but is greater than 10 mm, according to the selected materials. Likewise, the distance separating the points o and x is also sufficient to withstand the axial dissociation stresses and is ideally comprised between 20 mm and 200 mm but is greater than 10 mm, according to the selected materials.

The main body 22 of adapted shape and length is equipped with a cylindrical anti-friction cage 23, disposed at a predetermined distance from the point x. This cylindrical cage 23 determines in the center of gravity thereof a point o′. An axis of rotation D passes through the points o′ and x. The axes E and D describe therebetween a predetermined caster angle g. This cylindrical cage 23 is fastened on the main body 22 by means, which are not represented, such as screws or rivets, allowing its height position to be adjusted if necessary.

The warping element 5 is also equipped at its other end, according to the described embodiment, with a drive member 24 such as a handlebar, provided with two gripping members 25 such as handles. The center of gravity of the gripping members 25 defines a point k. According to a conventional device and not represented, the drive member 25 can be adjustable in height with respect to the main body 22 of the warping element 5 through which it can slide.

According to a variant which not represented, the respective shaft/bore functions of the elements 21 and 14 are reversed, the male portion then being located on the warping element 5 plunging through the female portion located on the rectilinear portion of the connecting element 3. The mechanical stresses governing this variant are the same as those described according to the preferred embodiment.

A removable retaining element 6 represented in FIG. 6 is made secured to the cylindrical cage 23 via a ring 26 which is captive therein. The inner diameter of the ring 26 is substantially greater than the outer diameter of the cylindrical cage 23. The ring 26 can therefore rotate freely but cannot perform any translational movement along the main body 22. The removable retaining element 6 also has a mandrel 27 located in a radial extension of the ring 26. The mandrel 27 is judiciously dimensioned such that it can collaborate with the cylindrical housing 18 of the connecting element 4. A pin housing 28 extends the mandrel 27 and collaborates with the pin 20 of the connecting element 4. The retaining element can therefore be pivotally connected to the upper end 17 of the connecting element 4.

The point o′ symbolizes the junction point between the warping element 5 and the connecting element 4, and is located on the axis D and at the center of gravity of the retaining element 6. A return axis F passes through the points k and x. An axis of rotation D passes through the points x and o′ and determines the axis of the possible rotation of the warping element 5 by means of the drive member 24. When the user drives the device according to the invention, each of the feet thereof, due to gravity, generates on the system through the connecting elements 3 and 4 a torque effect proportional to the width of the surfboard or of the pair of skis 1. This torque effect is balanced on the axis F and is countered by the action of the user on the drive member 25 to maintain its balance and its trajectory. Thus the offset distance d1 separating the point o′ from the axis F conditions the general balance of the drive forces between lateral inclination and axial rotation of the drive member 25 through the warping element 5. This distance is preferably comprised between 10 mm and 200 mm, more preferably comprised between 40 mm and 120 mm, and even more preferably comprised between 60 mm and 100 mm.

When the removable retaining element 6 is in place in the upper end 17 of the connecting element 4, the point o′ is made inseparable therefrom and at a fixed and predetermined distance from the connecting element 4. Thus when the device is at rest and the warping element 5 is not mobilized, the point o is at a zero or predetermined distance from the plane P and the point o′ is at a zero or predetermined distance from the plane P′.

The object of the invention is to impose an offset of the point o relative to the plane P and/or an offset of the point o′ relative to the plane P′ by means of a mobilization of the warping element 5, in particular by a rotational movement along the axis D thanks to the drive member 24; the distance separating the points o and o′ being fixed and predetermined.

According to a variant which is not represented, the locking function described below is ensured without a removable insert pin but in a single molded part, pivoting around the end 17 and having the ergots necessary to hang on a fixed axis disposed through the holes 19 of said end.

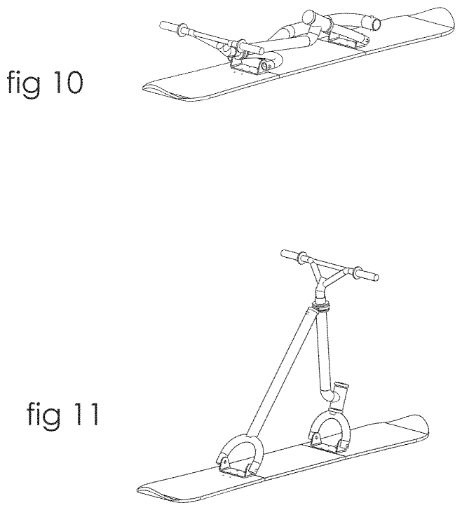

When the removable pin 20 is not disposed through the pin housing 28, then the connecting element 3, the warping element 5 as well as the removable retaining element 6, connected to each other, are no longer connected to the connecting element 4 as shown in FIG. 7A. The device according to the invention can then be folded back as shown in FIGS. 10A and 10B, which is practical for the ski lifts, the transport or even the storage.

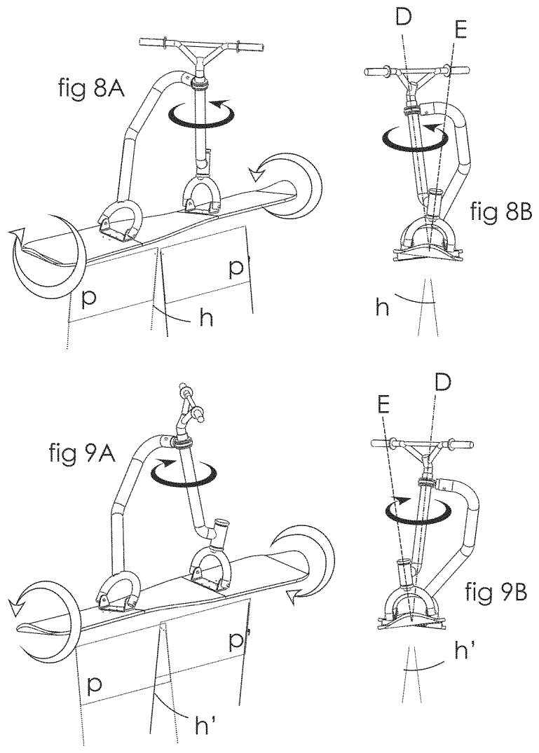

When the removable pin 20 is disposed jointly through the pin housing 28 and the axle hole 19, then the elements 3, 4, 5 and 6 are secured to each other (as represented in FIG. 1) and form in theory a hyperstatic assembly, allowing at least driving the board or pair of skis 1 by tilting the drive member 24 on either side of the axis A. The surfboards or skis nevertheless have some flexibility in construction. Thus, the rotation by the user of the drive member 24, along the axis of rotation D, is therefore possible and causes a deformation of the board or the pair of skis 1 in warping along the longitudinal axis A as illustrated by FIGS. 8A, 8B, 9A and 9B.

The warping element 5 is secured to the connecting element 3, but has at least one freedom of movement in rotation along the axis E relative to the connecting element 3, and this independently of the connecting element 4 which is not connected to the warping element 5 in FIGS. 7A and 7B. This displacement is possible in both directions, clockwise and counterclockwise, according to a minimum angular sector of at least 2°, preferably at least a few degrees, in particular 5°, more preferably at least 20°. In the preferred embodiment illustrated in the two FIGS. 7A and 7B, it is easily understood that this possible sector is 360°. According to other embodiments, a low angular freedom of the drive member 24 can be compensated by a higher value of the caster angle g for the same warping effect on the board or the pair of skis 1, but at the cost of a more significant effort on said drive member.

For the same angular sector of rotation of the drive member 24, along the axis of rotation D, the deformation by warping effect on the board or the pair of skis 1 will be proportional to the value of the predetermined caster angle g separating the two axes D and E. The value of g characterizing the angle between the axes E and D is at least 2°, preferably at least a few degrees, in particular 5°, more preferably at least 10°, in order to guarantee a perceptible torsional effect, and is preferably comprised between 10° and 40°, and even more preferably comprised between 20° and 30°. If the value of the predetermined angle g was equal to 0°, then the point o would be on the axis of rotation D and its radial displacement would be zero. In this case, the surfboard or the pair of skis 1 would not undergo any torsional deformation along the axis A.

The point o and the axis E are common (FIGS. 1, 3, 5) to the connecting element 3 and the warping element 5 characterizing their axial solidarity, as is represented in particular in FIGS. 7A and 7B. The rotation in a counterclockwise direction of the drive member 24 creates a warping angle h between the planes P and P′, characterizing the warping inducing a left turn of the board 1, as represented in FIGS. 8A and 8B. The clockwise rotation of the drive member 24 creates a warping angle h′ between the planes P and P′, characterizing the warping inducing a right turn of the board or the pair of skis 1, as represented in FIGS. 9A and 9B.

This deformation imposes the offset of the point o relative to the plane P and the point o′ relative to the plane P′. The warping angle h characterizes the amplitude of the warping effect on the board or the pair of skis 1, independently of the distance separating the points o and x, because it is the value of the caster angle g which determines this amplitude.

When the drive member 24 is rotated to the maximum of its amplitude of effect, that is to say +/−90° relative to its position at rest, then the angles h and h′ are equal to the predetermined caster angle g.

When the user drives his surfboard or his pair of skis, he engages a first foot substantially in the end 12 of the connecting element 3 and the second foot substantially in the end 15 of the connecting element 4. He can then laterally incline the board or the pair of skis 1 along the longitudinal axis A by means of the drive member 24, by leverage. He can simultaneously rotate said drive member along the axis of rotation D as desired clockwise or counterclockwise. This action therefore allows, in addition to the lateral leverage, to impose in a proportional and simultaneous manner a torsional stress on the board or the pair of skis 1 along the longitudinal axis A and characterized by the warping angle h between the planes P and P′. The warping element 5 then pivots about the axis D.

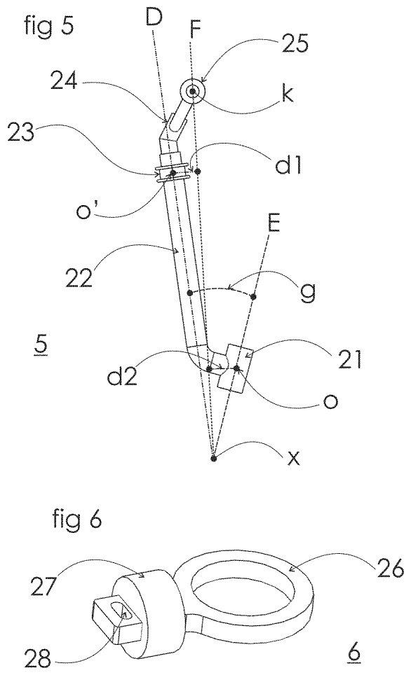

When the pilot laterally inclines the board or the pair of skis 1 about the axis A by means of the drive member 2, he takes it off from the snow towards the inner side thereof at the turn and is thus opposed by leverage to a force applied downwards by his own weight, proportionally to the width of the board or the pair of skis 1 and to the centrifugal force due to the speed of execution. This force exerted by each of his feet is successively transmitted to the drive member 24, on the one hand, by the first base 2, the connecting element 4, the removable retaining element 6 and the warping element 5; on the other hand, by the second base 2′, the connecting element 3 then again the warping element 5. The user resists this force by means of the gripping members 25 such as a pair of handles whose center of gravity is materialized by the point k in FIG. 1. This resistance is exerted by a leverage along the return axis F passing through the points k and x as represented in FIGS. 1 and 5. This leverage is proportional to the distance which separates the points k and x.

According to a variant described in relation to FIG. 11, the connecting element 4 is substantially rectilinear and parallel to the plane P. The legs of the user are then disposed on either side of the connecting element 4. According to another variant which is not represented, the retaining element 6 remains secured to the connecting element 4 and can be separated by the user from the warping element 5. According to a variant which is not represented, the point o′ and therefore the cylindrical cage 23 are deported from the main body 22 rearwards by means of supports which are suitable and fixed to the main body 22. According to this arrangement, the main body 22 is no longer co-axial with the axis of rotation D. The distance d1 being nevertheless maintained, the operation and the kinematics of the invention are not thereby modified.

According to a variant which is not represented, at least one profile made in particular of aluminum or composite materials is fastened in particular by means of screws on the ski or the surfboard at a zone for fastening the feet z. This profile is provided with at least one rail, preferably on its upper portion. The profile then acts as a support for a base 2 provided with holes, whose center distance collaborates judiciously with the rail(s) of said profile. Securing means, in particular screws, allow firmly connecting a profile and a base. By this arrangement, the base 2 and therefore the device connected thereto are adjustable according to the direction of the rail(s) of said profile. In addition, the assembly is easily dismountable and allows, in the case of a use on a pair of skis, to raise the base vis-à-vis the snow in order to avoid any accumulation of the latter which would then act as a brake.

According to another variant which is not represented, the device according to the invention is provided at the board or the pair of skis with a stop-ski type safety device such as those conventionally used for skiing and which are triggered and stop the device when the user's foot is no longer bearing thereon.

According to a variant represented in FIG. 2C, at least one base 2 is replaced by a pair of bases 2A and 2B, each secured respectively to a ski. These said bases therefore have, vis-à-vis each other, an axial freedom along the axis B but remain fully secured to the connecting element 4 thereof always along the axis B by means in particular of an axis 11 passing right through the four holes 10 of the lugs 9 of the concerned pair of bases. These bases 2A and 2B are no longer systematically coplanar with each other according to the zone z. The same device equips the connecting element 5.

According to another variant which is not represented, two bases constituting a pair are made secured to each other by means in particular of a metal screw connecting the two holes 10 of the inner lugs 9 located vis-à-vis each other. The reciprocal axial freedom of the two bases constituting the pair is respected.

According to another variant, a pair of bases is supported on at least four points parallel to the axis C by a connecting element or an adapted reinforcement of the connecting element and parallel to the axis C.

By this device, each ski has the freedom to interact independently of each other depending on the irregularities of the terrain, which constitutes a decisive advantage relative to the use of the invention on a surfboard. In addition, the torsional force to be performed on the handlebars is greatly reduced, and the general curvature of the skis under stress is more homogeneous.

1. A drive device for driving a pair of skis, comprising:
a first zone for fastening the feet, located substantially on a first half of the pair of skis, the perpendicular of the pair of skis at the first zone with a first axis, longitudinally passing through the pair of skis at the center of gravity thereof, forming a first plane with the first axis; and
a second zone for fastening the feet, located substantially on the second half of the pair of skis, the perpendicular of the pair of skis with the first axis at the second zone forming a second plane with the first axis,
the device comprising:
a first connecting element connected to the pair of skis at a first end by a first base at the first zone and constrained at least parallel to the first plane in a first point at a second end;
a second connecting element connected to the pair of skis at a third end by a second base at the second zone and constrained at least parallel to the second plane in a second point at a fourth end;
a warping element connected to the first connecting element at least at the first point, to the second connecting element at least at the second point, and maintaining a fixed and predetermined distance between the first and second points, the free mobilization of the warping element imposing an offset of the second point relative to the first plane and of the first point relative to the second plane.

2. The drive device according to claim 1, wherein the warping element is pivotally connected to the second connecting element about a second axis containing the second point, and can freely pivot about the second axis according to an angular sector of at least 2°.

3. The drive device according to claim 2, wherein the warping element is pivotally connected to the first connecting element about a third axis of rotation containing the first point, the second axis and the third axis having an angle of at least 2° between them.

4. The drive device according to claim 3, wherein the second connecting element is pivotally secured to the first base about a fourth axis and wherein the warping element comprises gripping members, the first point being located between the gripping members and the second point, the gripping members defining a fifth axis passing through the center of gravity of the gripping members and the point of intersection between the second axis and the fourth axis.

5. The drive device according to claim 4, wherein the first and second points are disposed on either side of the fifth axis.

6. The drive device according to claim 4, wherein the first point is coincident on the fifth axis.

7. The drive device according to claim 1, comprising a retaining element which connects the first connecting element with the warping element, and is made removable from at least the second connecting element or the warping element.

8. The drive device according to claim 1, wherein the first connecting element is not rectilinear.

9. The drive device according to claim 1, wherein the first connecting element is pivotally connected to the pair of skis about a sixth axis.

10. The drive device according to claim 5, comprising a retaining element which connects the first connecting element with the warping element, and is made removable from at least the second connecting element or the warping element.

11. The drive device according to claim 10, wherein the first connecting element is not rectilinear.

12. The drive device according to claim 11, wherein the first connecting element is pivotally connected to the pair of skis about a sixth axis.

13. The drive device according to claim 6, comprising a retaining element which connects the first connecting element with the warping element, and is made removable from at least the second connecting element or the warping element.

14. The drive device according to claim 13, wherein the first connecting element is not rectilinear.

15. The drive device according to claim 14, wherein the first connecting element is pivotally connected to the pair of skis about a sixth axis.

16. The drive device according to claim 4, comprising a retaining element which connects the first connecting element with the warping element, and is made removable from at least the second connecting element or the warping element.

17. The drive device according to claim 16, wherein the first connecting element is not rectilinear.

18. The drive device according to claim 17, wherein the first connecting element is pivotally connected to the pair of skis about a sixth axis.

19. The drive device according to claim 2, comprising a retaining element which connects the first connecting element with the warping element, and is made removable from at least the second connecting element or the warping element.

20. The drive device according to claim 3, comprising a retaining element which connects the first connecting element with the warping element, and is made removable from at least the second connecting element or the warping element.
